(19) United States
(12) Patent Application Publication
(10) Pub. No.: US 2020/0285626 A1
(43) Pub. Date: Sep. 10, 2020

(54) SYSTEMS AND METHODS FOR SECURELY STORING BUILDING MANAGEMENT DATA OF A BUILDING MANAGEMENT SYSTEM USING A BLOCKCHAIN

(71) Applicant: Honeywell International Inc., Morris Plains, NJ (US)

(72) Inventors: Rajagopal Palanivelu, Pondicherry (IN); Sruthi Karnam, Bangalore (IN); Srivatsa Haridas, Bangalore (IN); Rahul Kishore, Bangalore (IN); Seema Pathak, Bangalore (IN); Vanathi Ravindran, Bangalore (IN)

(21) Appl. No.: 16/291,348

(22) Filed: Mar. 4, 2019

(51) Int. Cl. G06F 16/23; G06F 16/27

(52) U.S. Cl. CPC G06F 16/23; G05B 15/02; G06F 16/27

(57) ABSTRACT

Systems and methods for securely storing building management data of building management systems in a blockchain are provided. Some methods can include detecting a change in the building management data of a first building management system, creating a new block for the blockchain, the new block representing the change in the building management data, broadcasting the new block to a second building management system, and adding the new block to the blockchain.

### FIELD

The present invention relates generally to building management systems. More particularly, the present invention relates to systems and methods for securely storing building management data of a building management system using a blockchain.

### BACKGROUND

Building management systems can include security systems, heating, ventilation, and air conditioning (HVAC) systems, fire safety systems, and access control systems. For example, security and fire safety systems are known to detect threats within a secured area, and such threats can include events that represent a risk to human safety or a risk to assets.

Security and fire safety systems typically include one or more sensors that can detect the threats within the secured area. For example, smoke, motion, contact, camera, gas, and/or intrusion sensors can be distributed throughout the secured area in order to detect the threats. Access control systems typically include a reader and an electronic lock that can unlock a door upon receiving a valid identification card or a key at the reader.

Known fire safety and security systems can send an alarm message to a central monitoring station upon activation of one of the sensors, and the central monitoring station can respond by summoning appropriate help. For example, if the one of the sensors detects a fire, then the central monitoring station can summon a local fire department. Alternatively, if the one of the sensors detects an intrusion, then the central monitoring station can summon the police.

Known building management systems typically communicate with a central server of the central monitoring station via a common standard protocol (e.g. BacNet, Modbus, EBI, WinMag, etc.). However, if one of the building management systems is offline or otherwise non-operational, then the central server cannot access all building management data. Furthermore, tracing history or creating restore points for each of the building management systems can be difficult. As such, there exists a need in the art for secure storage of the building management data of the building management systems.

### BRIEF DESCRIPTION OF THE DRAWINGS

FIG. 1 is a block diagram of a system in accordance with disclosed embodiments;

FIG. 2 is a block diagram of building management systems in accordance with disclosed embodiments;

FIG. 3 is a flow diagram of a method in accordance with disclosed embodiments;

FIG. 4 is a flow diagram of a method in accordance with disclosed embodiments; and

FIG. 5 is a flow diagram of a method in accordance with disclosed embodiments.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein can include systems and methods that can securely store building management data of building management systems using a blockchain. In some embodiments, the building management data described herein can include configuration data of the building management systems, maintenance data of the building management systems, security events, access events, temperature changes, or any other event tracked or detected by the building management systems, or any other data generated by the building management systems as would be known and understood by one of ordinary skill in the art. In some embodiments, the building management systems described herein can include fire safety systems, security systems, access control systems, HVAC systems, or any other type of building management system as would be known and understood by one or ordinary skill in the art.

In accordance with disclosed embodiments, a blockchain network can include a group of peers of the building management systems, such as the building management systems located in one site, the building management systems located in one building, the building management systems located on one floor, the building management systems located within a predetermined distance of one another, or the like. All of the building management systems in the blockchain network can create blocks in the blockchain, and each of the blocks in the blockchain can store respective building management data of a respective one of the building management systems in the blockchain network. Then, systems and methods disclosed herein can share all updates to the blockchain to all of the building management systems in the blockchain network so that each of the building management systems in the blockchain network and/or users thereof can be cognizant of the respective building management data of other ones of the building management systems in the blockchain network.

In some embodiments, only heterogeneous ones of the building management systems can store the building management data in the blockchain. That is, the heterogeneous ones of the building management systems can form the group of peers of the building management systems that forms the blockchain network. Accordingly, a first type of the building management systems, such as the fire safety systems, the HVAC systems, the access control systems, or the security systems, can store the building management data in a first blockchain, and a second, different type of the building management systems can store the building management data in a second blockchain.

The blockchain can represent an auditable trail of the building management data of the building management systems in the blockchain network that cannot be manipulated because such data is stored pursuant to blockchain protocols. For example, the blockchain protocols can prevent retroactive data manipulation because altering any of the blocks in the blockchain requires an alteration of subsequent ones of the blocks in the blockchain, which requires a consensus of all of the building management systems in the blockchain network. Furthermore, the blockchain protocols can ensure that the blockchain be completely decentralized such that all of the building management data in the blockchain can be shared with all of the building management systems in the blockchain network.

In accordance with the above, the building management systems in the blockchain network can execute smart contracts, and the smart contracts can include self-executing codes (e.g. software) that are designed to execute a command or an action when the self-executing codes are exposed to a trigger, such as data input or a change to the building management data. In some embodiments, the smart contracts can send the updates to the blockchain to an open-source ledger representative of the blockchain so that additions and subtractions to a maintenance record or the building management data can be accessed by any building stakeholder, such as a maintenance engineer reviewing periodic maintenance records, a building owner ensuring compliance with building management system standards, an insurance company auditing an insurance claim, a tenant, or the like. For example, when a commissioning engineer adds a new entry to the maintenance record (e.g. replacing a broken security sensor with a replacement security sensor), a security system can create a new block in the blockchain representing the replacement security sensor, and the new block can be broadcast to all of the building management systems in the blockchain network. Substantially simultaneously, a respective one of the smart contracts can send a corresponding update to the open-source ledger, and a notification message to view the open-source ledger to one or more building stakeholders. After receiving a broadcast identifying the new block added to the blockchain, some or all of the building management systems in the blockchain network can validate the new block.

In some embodiments, each of the blocks in the blockchain can include a respective transaction identifier that identifies a respective one of the blocks in the blockchain, a hash of a respective previous block identifier, a respective timestamp, and a hash of the respective building management data from the respective one of the building management systems in the blockchain network creating the respective one of the blocks in the blockchain. In this regard, the respective previous block identifier of a second of the blocks in the blockchain can include the respective transaction identifier of a first of the blocks in the blockchain. Because each of the blocks in the blockchain contains the hash of the respective previous block identifier, the blocks in the blockchain can be linked using cryptography.

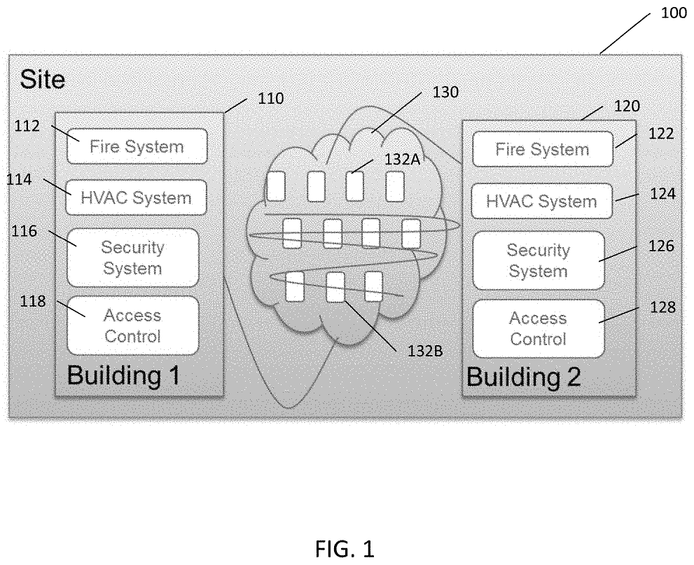

FIG. 1 is a block diagram of a system located in a site (e.g. a secured area) 100 in accordance with disclosed embodiments. As seen in FIG. 1, the site 100 can include one or more buildings 110, 120, and each of the buildings 110, 120 can include one or more building management systems. For example, a first of the buildings 110 can include a first fire safety system 112, a first HVAC system 114, a first security system 116, and a first access control system 118. Similarly, a second of the buildings 120 can include a second fire safety system 122, a second HVAC system 124, a second security system 126, and a second access control system 128.

In some embodiments, the first and second fire safety systems 112, 122 can include smoke detectors that can detect smoke or a fire within the site 100. Furthermore, in some embodiments, the first and second HVAC systems 114, 124 can include thermostats, fans, heaters, and air conditioning units to regulate temperatures within the buildings 110, 120. Further still, in some embodiments, the first and second security systems 116, 126 can include motion detectors, door sensors, window sensors, glass break sensors, and the like to detect intrusions within the site 100. Yet further still, in some embodiments, the first and second access control systems 118, 128 can include readers and door lock control mechanisms to control access to areas and subareas within the site 100.

In any embodiment, each of the building management systems in the buildings 110, 120, including the first fire safety system 112, the first HVAC system 114, the first security system 116, the first access control system 118, the second fire safety system 122, the second HVAC system 124, the second security system 126, and the second access control system 128, can store respective building management data in a blockchain 130 that can include one or more blocks 132A, 132B. For example, any time one of the building management systems in the buildings 110, 120 is updated with new building management data, that one of the building management systems can create a new one of the blocks 132A, 132B in the blockchain 130, and responsive thereto, that one of the building management systems can broadcast the new one of the blocks 132A, 1326 or the blockchain 130 as a whole to all of the building management systems in the buildings 110 120. Then, each of the building management systems in the buildings 110, 120 can store a copy of the blockchain 130 with the new one of the blocks 132A, 132B added thereto.

Each of the building management systems in the buildings 110, 120 can include respective control circuitry, which can include a respective programmable processor and respective executable control software, as would be understood by one of ordinary skill in the art. The respective executable control software of each of the building management systems in the buildings 110, 120 can be stored on a transitory or non-transitory computer readable medium, including, but not limited to local computer memory, RAM, optical storage media, magnetic storage media, and the like. In some embodiments, the respective control circuitry, the respective programmable processor, and the respective executable control software of each of the building management systems in the buildings 110, 120 can execute and control some or all of the methods disclosed herein.

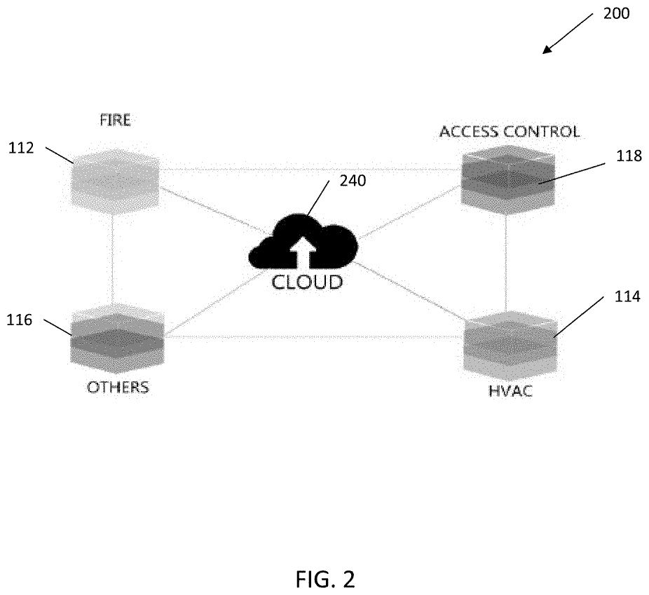

FIG. 2 is a block diagram of a system 200 in accordance with disclosed embodiments. The system 200 can be similar to or include all or part of the system located in the site 100 of FIG. 1.

As seen in FIG. 2, the system 200 can include some or all of the building management systems in the buildings 110, 120, such as the first fire safety system 112, the first HVAC system 114, the first security system 116, the first access control system 118, or any other building management system as would be known and understood by one or ordinary skill in the art. Each of the building management systems in the system 200 can communicate with other ones of the building management systems in the system 200 and with a cloud server or device 240 pursuant to smart contracts defining the blockchain 130, which, in some embodiments can be stored in memory devices of the building management systems of the system 200 and/or the cloud server or device 240. In this regard, interconnectivity of all of the building management systems in the system 200 can facilitate peer-to-peer broadcasting of updates to the blockchain 130, such as when the new one of the blocks 132A, 132B is added to the blockchain 130.

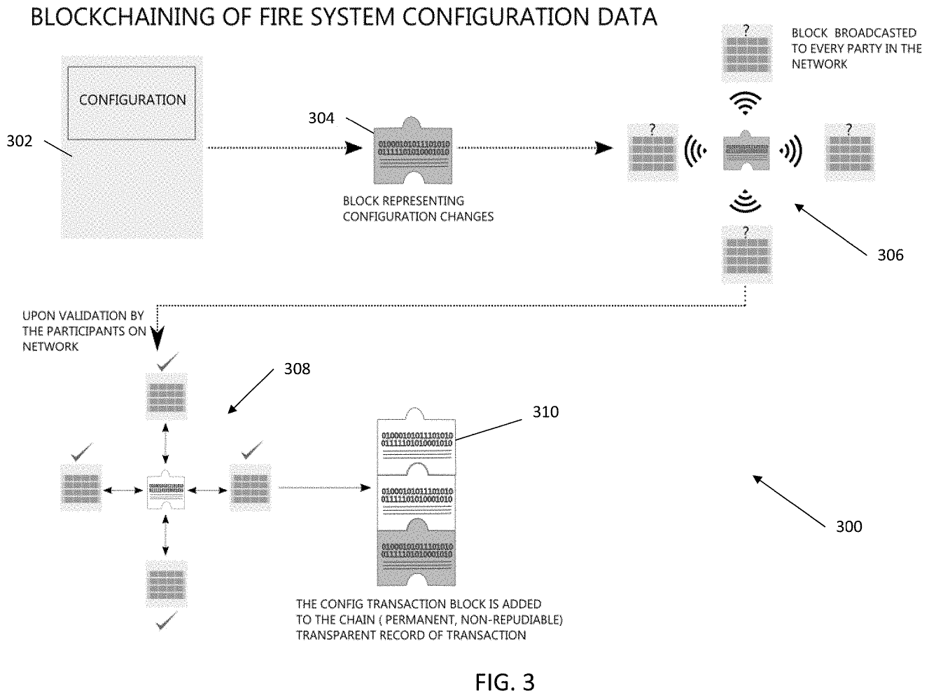

FIG. 3 is a flow diagram of a method 300 for updating a blockchain (e.g. the blockchain 130) in accordance with disclosed embodiments. As seen in FIG. 3, the method 300 can include a processor (e.g. a processor of any of the building management systems in the buildings 110, 120 or in the system 200) updating its building management data as in 302, and the processor creating a new block for the blockchain representing updates to the building management data as in 304. In some embodiments, the processor can update the building management data responsive to a command or other user input from a commissioning engineer or responsive to a maintenance event in an associated building management system. Furthermore, in some embodiments, the new block can include a transaction identifier that identifies the new block, a hash of a previous block in the blockchain, a hash of the updates to the building management data, and a timestamp. In some embodiments, the processor can create the hashes using a hashing algorithm, such as SHA-256.

Then, the method 300 can include the processor broadcasting the new block to all peers in an associated blockchain network (e.g. all other ones of the building management systems in an associated site) as in 306, the processor receiving a validation confirmation message from all of the peers in the associated blockchain network as in 308, and responsive thereto, the processor saving the new block to the blockchain as in 310. In some embodiments, after the processor saves the new block to the blockchain, the method 300 can also include the processor transmitting the new block in the blockchain to all of the peers in the associated blockchain network or transmitting the blockchain as a whole to all of the peers in the associated blockchain network.

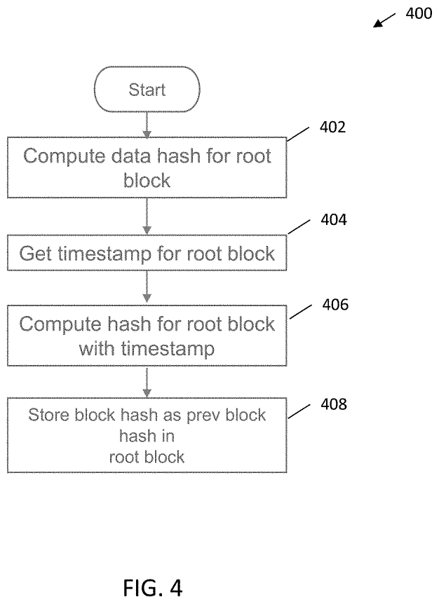

FIG. 4 is a flow diagram of a method 400 for creating a root block in a blockchain (e.g. the blockchain 130) in accordance with disclosed embodiments. As seen in FIG. 4, the method 400 can include a processor (e.g. a processor of any of the building management systems in the buildings 110, 120 or in the system 200) computing a data hash for the root block as in 402, the processor receiving a timestamp for the root block as in 404, the processor computing a block hash for the root block with the timestamp as in 406, and the processor storing the block hash as a previous block hash identifier for the root block as in 408. In some embodiments, the processor can use a hashing algorithm to create the data hash and the block hash.

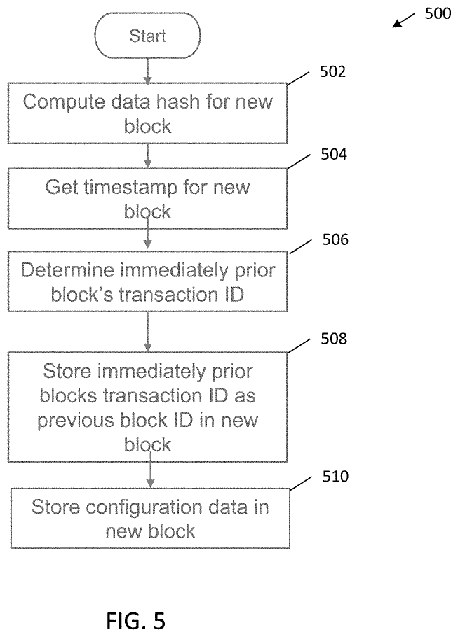

FIG. 5 is a flow diagram of a method 500 for creating a new block in a blockchain (e.g. the blockchain 130) in accordance with disclosed embodiments. As seen in FIG. 5, the method 500 can include a processor (e.g. a processor of any of the building management systems in the buildings 110, 120 or in the system 200) computing a data hash for the new block as in 502, the processor receiving a timestamp for the new block as in 504, the processor retrieving a transaction identifier from a previous block in the blockchain as in 506, the processor storing the transaction identifier of the previous block as a previous block identifier in the new block as in 508, and the processor storing building management data in the new block as in 510. In some embodiments, the processor can compute and store the previous block identifier as a hash of the previous block identifier and/or can compute and store the building management data as a hash of the building management data, and in these embodiments, the processor can use a hashing algorithm to create these hashes.

The exemplary embodiments described herein greatly improve and provide several advantages over the prior art systems and methods for storing building management data of building management systems. First, by using a blockchain, the building management data in systems and methods disclosed herein can be transparent and auditable, which can allow for traceability thereof. Indeed, in some embodiments, a full snapshot of the building management data can be stored in each block of the blockchain, thereby facilitating a configuration reset from any of the blocks in the blockchain. Second, due to smart contracts, all data consumers can be assured that the building management data in systems and methods disclosed herein is consistent, complete, timely, and accurate. Next, because the blockchain can be shared with all peers in a blockchain network, the building management data in systems and methods disclosed herein can always be available as long as one of the building management systems is operational. Said differently, because the blockchain has no central authority, there is no central point of failure, and the blockchain can withstand malicious attacks. Finally, because the blockchain relies upon cryptography, the building management data in systems and methods disclosed herein can be highly secure.

Although a few embodiments have been described in detail above, other modifications are possible. For example, the logic flows described above do not require the particular order described or sequential order to achieve desirable results. Other steps may be provided, steps may be eliminated from the described flows, and other components may be added to or removed from the described systems. Other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the spirit and scope of the invention.

What is claimed is:

1. A method comprising:
detecting a change in building management data of a first building management system;
creating a new block for a blockchain, the new block representing the change in the building management data;
broadcasting the new block to a second building management system; and
adding the new block to the blockchain.

2. The method of claim 1 further comprising:
receiving a validation confirmation message from the second building management system validating the new block; and
responsive to the validation confirmation message, adding the new block to the blockchain.

3. The method of claim 1 wherein the new block includes a first transaction identifier and a previous block identifier.

4. The method of claim 3 wherein the previous block identifier references a second transaction identifier of a previous block in the blockchain.

5. The method of claim 4 wherein the new block includes a timestamp.

6. The method of claim 5 further comprising:
linking the new block to the previous block using cryptography.

7. The method of claim 1 wherein the change in the building management data includes maintenance data representing maintenance performed on a device in the first building management system.

8. The method of claim 1 wherein the first building management system includes a fire safety system, a security system, a heating, ventilation, and air conditioning (HVAC) system, or an access control system.

9. The method of claim 1 wherein detecting the change in the building management data includes the change in the building management data triggering a smart contract associated with the blockchain.

10. The method of claim 1 further comprising:
the first building management system storing the blockchain with the new block added thereto in a first computer-readable medium; and
the second building management system storing the blockchain with the new block added thereto in a second computer-readable medium.

11. A system comprising:
a first programmable processor in a first building management system; and
first executable control software stored on a first non-transitory computer readable medium in the first building management system,
wherein the first programmable processor and the first executable control software detect a change in building management data of the first building management system,
wherein the first programmable processor and the first executable control software create a new block for a blockchain,
wherein the new block represents the change in the building management data,
wherein the first programmable processor and the first executable control software broadcast the new block to a second building management system, and
wherein the first programmable processor and the first executable control software add the new block to the blockchain.

12. The system of claim 11 wherein the first programmable processor and the first executable control software receive a validation confirmation message from the second building management system validating the new block, and wherein, responsive to the validation confirmation message, the first programmable processor and the first executable control software add the new block to the blockchain.

13. The system of claim 11 wherein the new block includes a first transaction identifier and a previous block identifier.

14. The system of claim 13 wherein the previous block identifier references a second transaction identifier of a previous block in the blockchain.

15. The system of claim 14 wherein the new block includes a timestamp.

16. The system of claim 15 wherein the first programmable processor and the first executable control software link the new block to the previous block using cryptography.

17. The system of claim 11 further comprising:
a sensor in the first building management system,
wherein the change in the building management data includes maintenance data representing maintenance performed on the sensor.

18. The system of claim 11 wherein the first building management system includes a fire safety system, a security system, a heating, ventilation, and air conditioning (HVAC) system, or an access control system.

19. The system of claim 11 wherein, responsive to the first programmable processor and the first executable control software detecting the change in the building management data, the first programmable processor and the first executable control software trigger a smart contract associated with the blockchain.

20. The system of claim 11 wherein the first programmable processor and the first executable control software store the blockchain with the new block added thereto in the first non-transitory computer readable medium, and wherein a second programmable processor in the second building management system and second executable control software in the second building management system store the blockchain with the new block added thereto in a second non-transitory computer readable medium in the second building management system.
